(19) United States
(12) Patent Application Publication
(10) Pub. No.: US 2023/0213950 A1
(43) Pub. Date: Jul. 6, 2023

(54) Adjustable Washing Assembly for a Car Wash System

(71) Applicant: Innovative Control Systems, Inc., Bethlehem, PA (US)

(72) Inventor: Kevin Detrick, Bethlehem, PA (US)

(21) Appl. No.: 18/093,845

(22) Filed: Jan. 6, 2023

Related U.S. Application Data
(60) Provisional application No. 63/297,141, filed on Jan. 6, 2022.

(51) Int. Cl. G05D 3/12; B60S 3/06; B60S 3/00

(52) U.S. Cl. CPC G05D 3/125; B60S 3/066; B60S 3/004

(57) ABSTRACT

A car wash system is disclosed. The car wash system can include an adjustable top washer, a sensor configured to determine a height measurement of the vehicle, an actuator configured to adjust a position of the top washer, and a control system coupled to the actuator and the sensor. The control system can be configured to receive the height measurement of the vehicle from the sensor and control the actuator to adjust the position of the top washer based on the received height measurement.

### CROSS-REFERENCE TO RELATED APPLICATION

This application claims the benefit of U.S. Provisional Application Ser. No. 63/297,141 titled Adjustable Washing Assembly For A Car Wash System and filed Jan. 6, 2022, which is hereby incorporated herein by reference in its entirety.

### BACKGROUND

Car wash systems generally include a top washer that faces the exit of the car wash, i.e., the “exit-facing” or “rear-facing” top washer. This top washer moves with the front of the vehicle and lifts over the front of the vehicle as the vehicle moves through the car wash. Further, the top washer falls off the back of the vehicle and moves away from the vehicle as the vehicle passes by the top washer. This exit-facing top washer does not clean the rear of the vehicle. Accordingly, car wash systems can generally also include a top washer that faces the entrance of the car wash, i.e., the “entrance-facing” or “forward-facing” top washer. This second top washer follows the rear of the vehicle and moves in the direction of the vehicle as the top washer descends down the rear of the vehicle. Therefore, these two washers wash the front, top, and rear of the vehicle in combination with each other.

There can be issues with the entrance-facing top washer though for vehicles that have high fronts. In particular, in the top washer is too low in relation to the front of the vehicle being washed by the car wash system, then the top washer can become jammed or stuck against the vehicle. For example, in conventional car wash systems, the entrance-facing top washer is generally positioned at a height of 21″ from the floor of the car wash system. However, some vehicles (e.g., SUVs and pick-up trucks) have high front ends that can trap the top washer between the lower stop and the vehicle when the top washer is positioned at that height. Because the top washer must move into or against the vehicle to lift up over the vehicle, if the top washer becomes stuck on a portion of the front end of the vehicle, the vehicle can push the top washer down. This pins the top washer against the vehicle. Ultimately, the top washer prevents the forward motion of the vehicle, thereby causing the rollers to pass under the wheels, which in turn causes the vehicle to stop in the car wash tunnel. If the following vehicle is not halted in sufficient time, the following vehicle can collide with the stopped vehicle, which can obviously result in damage to both vehicles. Further, the top washer can also become damaged due to the force exerted by the vehicle on the piece of washing equipment.

There are also multiple other issues with conventional top washer assemblies. For example, car wash top washers conventionally include a retract cylinder that is designed to lift the top washer out of a vehicle's path when the wash is not in use (because customers occasionally drive through the wash when it is not in use). The retract cylinder also provides a downward force on the primary arm to control the penetration/weight of the top washer on the vehicle. The stroke of the retract cylinder typically makes it very difficult to follow the back of the vehicle being washed, lift up above the hood of a large vehicle (e.g., an SUV), and then bring the washer back down to wash the top or horizontal surface of the vehicle. In particular, there is too much inertia to move the top washer up and then back down for the next vehicle. The range of motion and the distance that the top washer is travelling is also too large, resulting in the top washer missing the hood of the following vehicle or getting trapped in front of the following vehicle. Notably, vehicles are conventionally spaced approximately 84″ apart in an automatic car wash tunnel and the conveyor can be moving at speeds up to 16″ per second. Accordingly, the top washer has 5.25 seconds to reverse direction and lift up and then change direction and drop down onto the hood of the next vehicle. If air pressures are too high, the top washer will move too quickly and hit the travel limiting stops or the vehicle with a lot of force. If the air pressures are too low, the top washer will move too slowly and get trapped by the front of the following vehicle in the queue. Accordingly, conventional vehicle spacing in car wash systems creates significant issues with controlling the movement of the top washer assemblies and can result in the top washer assemblies getting trapped against vehicles, among other issues.

Therefore, it would be highly advantageous for a car wash system to automatically adjust the height at which the top washer is positioned according to the size or height of the vehicle (particularly, the front end of the vehicle) to address these and other issues.

### SUMMARY

Described herein are embodiments of an adjustable washing assembly for a car wash, particularly an adjustable top washer. Further, described herein are embodiments of systems and methods of controlling the same.

In one embodiment, there is provided a car wash system for washing a vehicle, the car wash system comprising: a top washer configured to move between a first position and a second position; a sensor configured to determine a height measurement of the vehicle; an actuator coupled to the top washer, the actuator configured to move the top washer between the first position and the second position; and a control system coupled to the actuator and the sensor, the control system configured to: receive the height measurement of the vehicle from the sensor, and control the actuator to cause the top washer to be positioned at the first position or the second position based on the received height measurement.

In one embodiment, there is provided a car wash system for washing a vehicle, the car wash system comprising: a top washer; a sensor configured to determine a height measurement of the vehicle; an actuator coupled to the top washer, the actuator configured to adjust a position of the top washer with respect to the vehicle; and a control system coupled to the actuator and the sensor, the control system configured to: receive the height measurement of the vehicle from the sensor, and control the actuator to adjust the position of the top washer based on the received height measurement.

In one embodiment, there is provided a method of controlling a top washer of a car wash system, the car wash system comprising the top washer, a sensor configured to determine a height measurement of a vehicle being washed by the car wash system, and an actuator coupled to the top washer, the method comprising: receiving, by a control system, the height measurement of the vehicle from the sensor; determining, by the control system, whether a first position of the top washer is suitable for the vehicle based on the received height measurement; controlling, by the control system, the actuator to cause the top washer to move from the first position to the second position.

### FIGURES

The accompanying drawings, which are incorporated in and form a part of the specification, illustrate the embodiments of the invention and together with the written description serve to explain the principles, characteristics, and features of the invention. In the drawings:

FIG. 1 is a diagram of a car wash system, in accordance with at least one aspect of the present disclosure.

FIG. 2 is a diagram of an adjustable top washer assembly at a first height in relation to a vehicle, in accordance with at least one aspect of the present disclosure.

FIG. 3 is a diagram of an adjustable top washer assembly moving from a first height to a second height, in accordance with at least one aspect of the present disclosure.

FIG. 4 is a diagram of an adjustable top washer assembly at a second height, in accordance with at least one aspect of the present disclosure.

FIG. 5 is a perspective view of the adjustable top washer assembly, in accordance with at least one aspect of the present disclosure.

FIG. 6 is a detail view of the actuator assembly of the adjustable top washer assembly, in accordance with at least one aspect of the present disclosure.

FIG. 7 is a side view of the adjustable top washer assembly, in accordance with at least one aspect of the present disclosure.

FIG. 8 is a second detail view of the actuator assembly of the adjustable top washer assembly, in accordance with at least one aspect of the present disclosure.

FIG. 9 is a third detail view of the actuator assembly of the adjustable top washer assembly from a reverse angle with respect to FIG. 7, in accordance with at least one aspect of the present disclosure.

FIG. 10 is a side view of the adjustable top washer assembly, wherein the rotary brush head is in a first position, in accordance with at least one aspect of the present disclosure.

FIG. 11 is a side view of the adjustable top washer assembly, wherein the rotary brush head is in a second position, in accordance with at least one aspect of the present disclosure.

FIG. 12 is a side view of the top washer assembly demonstrating the full range of movement thereof, in accordance with at least one aspect of the present disclosure.

FIG. 13 is a detail sectional view of the actuator and the breakaway clutch assembly, in accordance with at least one aspect of the present disclosure.

FIG. 14 is detail perspective view of the actuator and the breakaway clutch assembly, in accordance with at least one aspect of the present disclosure.

FIG. 15 is a side view of the top washer assembly wherein the rotary brush is at a maximum downward stop position, in accordance with at least one aspect of the present disclosure.

FIG. 16 is a side view of the top washer assembly wherein the rotary brush is at a secondary downward stop position, in accordance with at least one aspect of the present disclosure.

FIG. 17 is a detail view of the adjustable downward stop assembly, in accordance with at least one aspect of the present disclosure.

FIG. 18 is a side view of the top washer assembly wherein the rotary brush is at an upward stop position, in accordance with at least one aspect of the present disclosure.

### DESCRIPTION

This disclosure is not limited to the particular systems, devices, and methods described, as these may vary. The terminology used in the description is for the purpose of describing the particular versions or embodiments only, and is not intended to limit the scope.

### Car Wash System

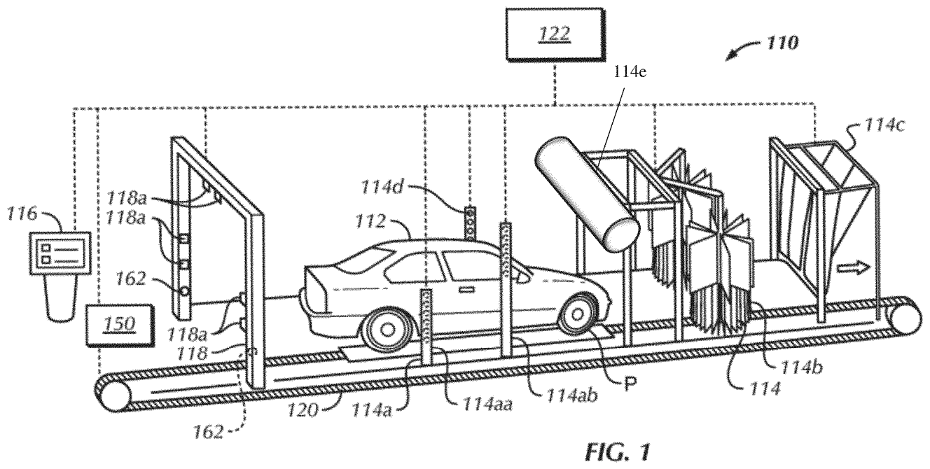

Various embodiments described herein can be used in conjunction with or as components of a car wash system 110, which is illustrated in FIG. 1. The car wash system 110 can include a control system 122, a sensor assembly that is configured to sense various parameters associated with the vehicle (e.g., the height of the vehicle or components thereof, the profile of the vehicle, or the speed of the vehicle), and wash equipment 114. In one embodiment, the car wash system 110 can be embodied as a car wash tunnel. In one embodiment, the sensor assembly could include a scanning arch 118, such as in the embodiment shown in FIG. 1; however, this is simply provided for illustrative purposes and other embodiments can include other sensor assemblies in addition to or in lieu of the depicted scanning arch 118. The scanning arch 118 can include one or more sensors 118a that are configured to measure parameters associated with the vehicle 112. In one embodiment, the sensors 118a can be configured to measure a height of a portion (e.g., the hood) of the vehicle 112. In another embodiment, the sensors 118a can be configured to determine a contour of the vehicle 112. In one embodiment, the scanning arch 118 can further include a vehicle sensor 162 (e.g., a gate switch) that is configured to detect the presence of the vehicle 112. In one embodiment, the car wash system 110 can further include a conveyor 120 configured to move the vehicle 112 therethrough.

Embodiments disclosed herein include a method and system for obtaining one or more outer contour measurements of a vehicle 112. The one or more contour measurements of the vehicle 112 may be transferred to automated vehicle wash equipment 114 such that the wash equipment 114 may accurately, efficiently, and closely wash the vehicle 112 while reducing or eliminating damage to the vehicle 112 caused by the wash equipment 114. In one embodiment, the commands for operating the wash equipment 114 may be based, at least in part, on the measured speed and/or position of the conveyor 120 moving the vehicle 112 through the wash equipment 114.

In one embodiment, the car wash system 110 includes a computer-assisted wash system in which each vehicle 112 is profiled, system parameters are monitored, and washing equipment 114 is precisely controlled, to deliver an optimal wash. In one embodiment, the profile is a three-dimensional representation of the vehicle 112. In one embodiment, the profile is a series of two-dimensional representations or slices of the vehicle 112 taken every predetermined distance the vehicle 112 is moved along by the conveyor 120. In one embodiment, the system parameter that is monitored is the position of the conveyor 120 relative to the scanning arch 118. In one embodiment, the system parameter that is monitored is the speed of the conveyor 120. In one embodiment, the system parameter that is monitored is water, chemical, and/or energy usage as described further below.

In one embodiment, the system 110 accepts wash service inputs from a user into a kiosk 116 and then the conveyor 120 guides the vehicle 112 through the wash tunnel. A control system 122 may sense the vehicle movement and/or determine the position of the vehicle 112 based on the vehicle profile and/or conveyor speed and/or position and activate mechanical washing equipment 114 at appropriate points during the wash cycle. In one embodiment, the control system 122 has an accuracy of one (1) inch of chain travel, and is capable of integrated web-based management plus enhanced diagnostics and error reporting capabilities. In some embodiments, the control system 122 may be configured to position the wash equipment 114 in order to properly wash the vehicle 112 and/or prevent damage to the wash equipment 114 or the vehicle 112.

In some embodiments, car wash system 110 may include software management systems such as Tunnel Master (TM)™, Lube Master (LM), Point of Sale (POS), AutoSentry-A (ASA), Auto Sentry-eXP (AS-eXP), Auto Sentry-FLEX, Wash Valet, and/or TouchNClean. The car wash system 110 may also include one or more embedded micro controller/microprocessor based equipment control products such as Input Terminal, Tunnel Master Junior (TMJ), and a Web Based Controller (WBC). Input terminals or a kiosk 116 may be used for accepting wash services orders from a customer or user prior to entering the wash.

In one embodiment, management system software allows system operators to configure various devices, cash management, and view reports. The management system Lube Master, for example, may deliver increased operating efficiency and improved profitability in a similar way it does for the quick lube industry. Self-service kiosk systems such as Auto Sentries & TouchNCleans may be used to offer various options for the user to buy available vehicle wash services and packages through the kiosk 116.

The washing equipment can include, for example, brushes or wraps 114b, chemical arches 114a, 114aa, 114ab, dryers 114c, spray nozzles 114d, or top washers 114e, including the various embodiments of top washer assemblies described below. The control system 122 can be configured to activate and/or control the positioning of the various pieces of wash equipment 114 based on a variety of different parameters, including measurements associated with the vehicle 112 being washed. In various embodiments, the control system 122 can include various combinations of hardware, software, and/or firmware that are configured to execute the various tasks described herein. For example, the control system 122 could include a computer system comprising a processor and a memory coupled to the processor, wherein the memory stores instructions that, when executed by the processor, cause the computer system to perform the described tasks. However, the control system 122 could also include or be embodied as an application-specific integrated circuit (ASIC), field-programmable gate array (FPGA), and/or other hardware or firmware that is configured to perform the described tasks.

In one embodiment, the car wash system 110 can include additional sensors, such as a sensor 150 (e.g., a pulse switch) that is configured to measure chain travel of the conveyor 120 such that the wash equipment 114 downstream of the scanning arch 118 follows the measured contour of the vehicle at the appropriate time. In other embodiments, the car wash system 100 can use the sensor arch 118 to perform an initial measurement of the vehicle 112 (e.g., the height of the hood or front end of the vehicle 112) and correspondingly adjust the positioning of the wash equipment 114 (e.g., the top washer 114e) based on a sensed output from the wash equipment 114 (e.g., motor torque or amperage), as described in greater detail below. This embodiment can be beneficial because it can reduce complexity by having the control system 122 read the motor torque digital output, thereby allowing the control system 112 to control the positioning of the wash equipment 114 by following the motor torque to the contour the vehicle 112 being washed.

The car wash system 110 can be configured to control one or more equipment parameters associated with the wash equipment 114 based upon measured characteristics associated with the vehicle 112, such as the height of the hood or the contour of vehicle 112, and/or system parameters. For example, equipment parameters could include motor operating speed, angular velocity of wash equipment, length of travel of wash equipment, position of wash equipment, chemical application rates, chemical application location, and/or chemical application quantities. For example, system parameters could include the speed of the vehicle conveyor 120 and vehicle position on the conveyor. In one embodiment, the measured characteristic(s) of the vehicle 112 could be measured with respect to a physical reference point P (e.g., a point on the inside rail of the conveyor 120).

Additional information regarding car wash systems can be found in U.S. Pat. No. 10,266,155, titled METHOD AND SYSTEM FOR WASHING A VEHICLE, filed May 1, 2013; U.S. Pat. No. 10,994,706, titled METHOD AND SYSTEM FOR WASHING A VEHICLE, filed Nov. 20, 2018; and U.S. patent application Ser. No. 15/942,979, published as US2018/0281752A1, titled METHOD AND SYSTEM FOR WASHING A VEHICLE, filed Apr. 2, 2018, each of which is hereby incorporated by reference herein in its entirety.

### Adjustable Top Washer Assembly

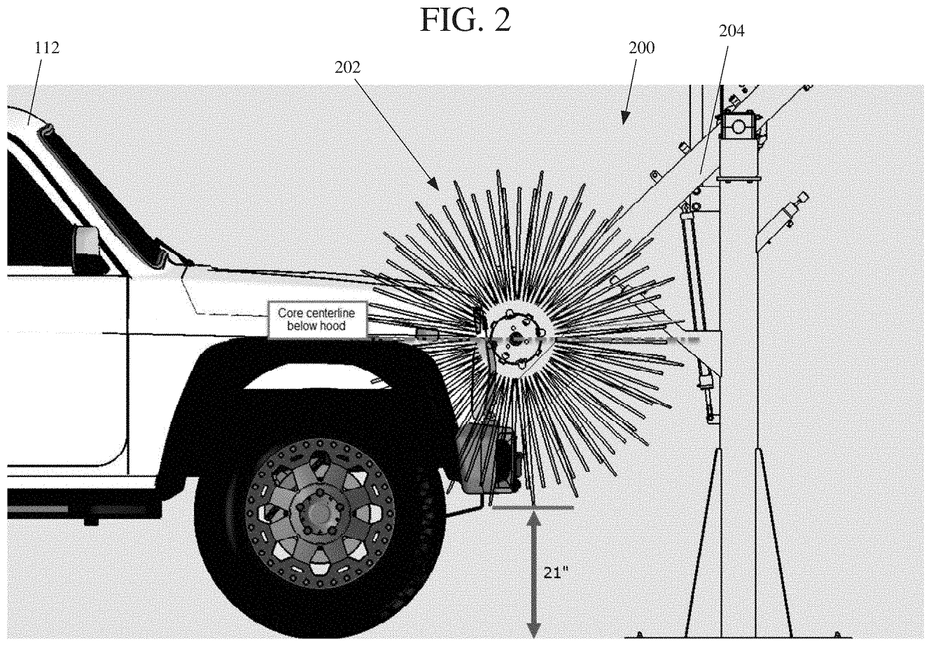

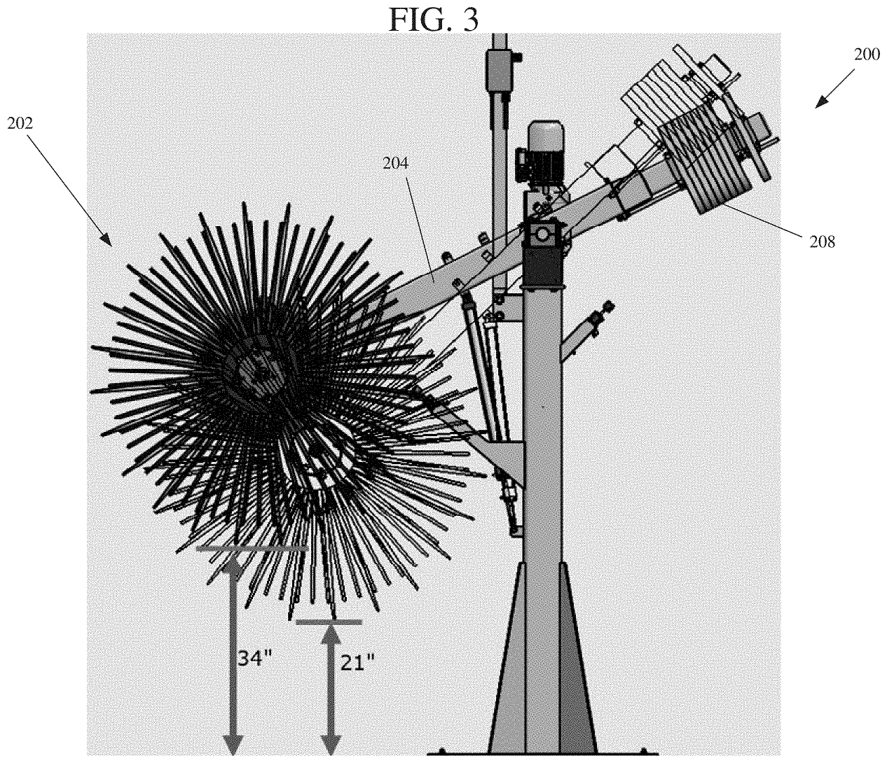

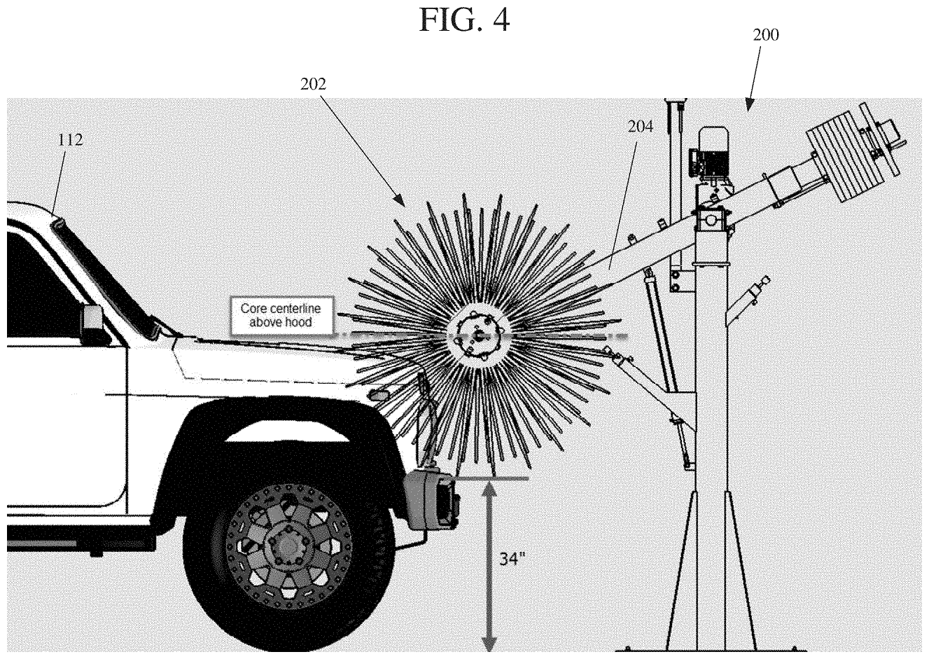

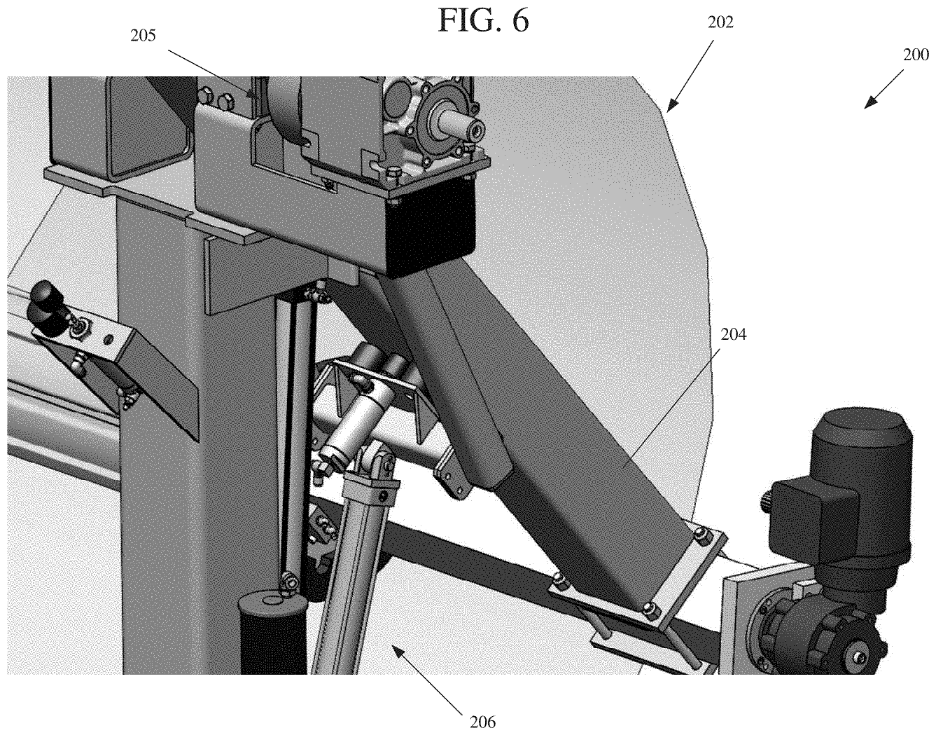

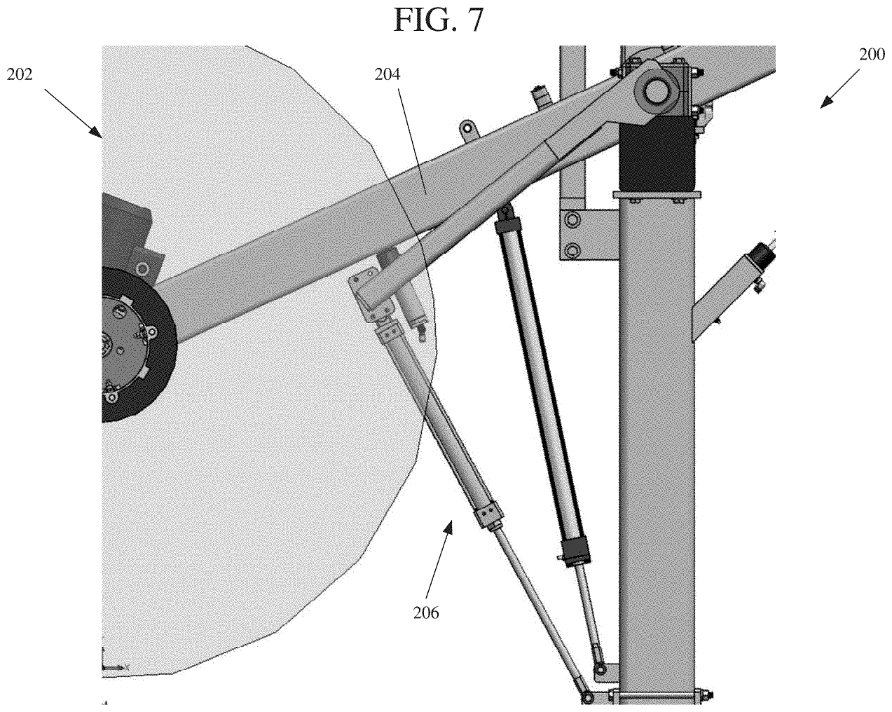

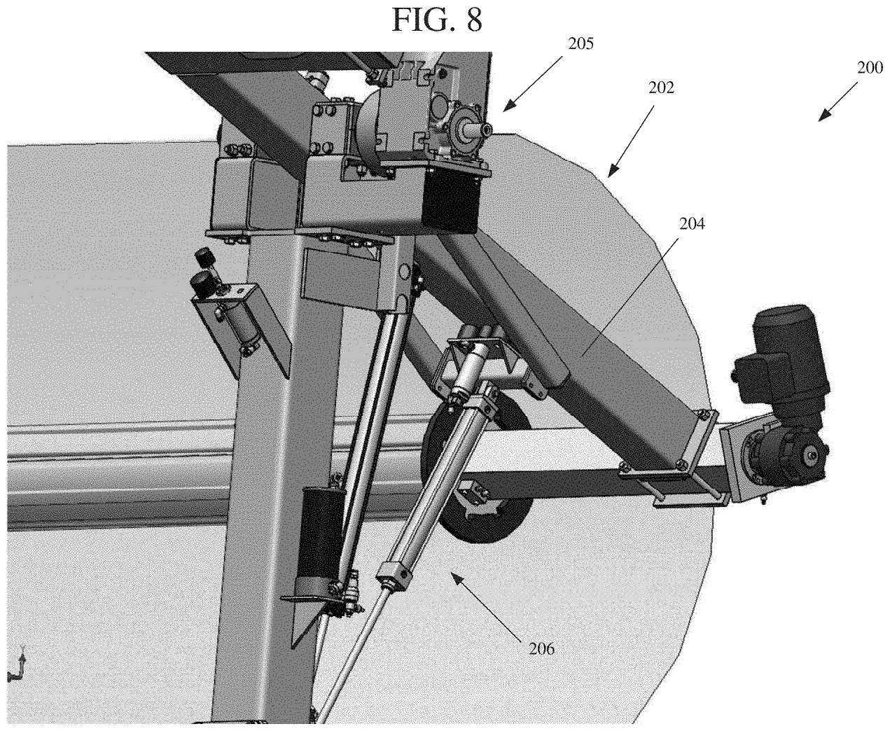

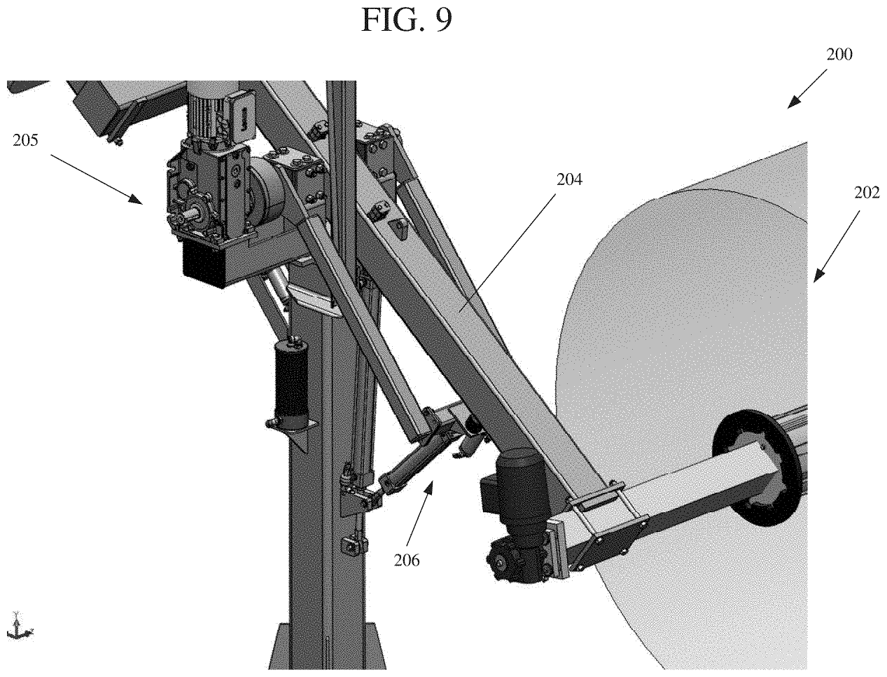

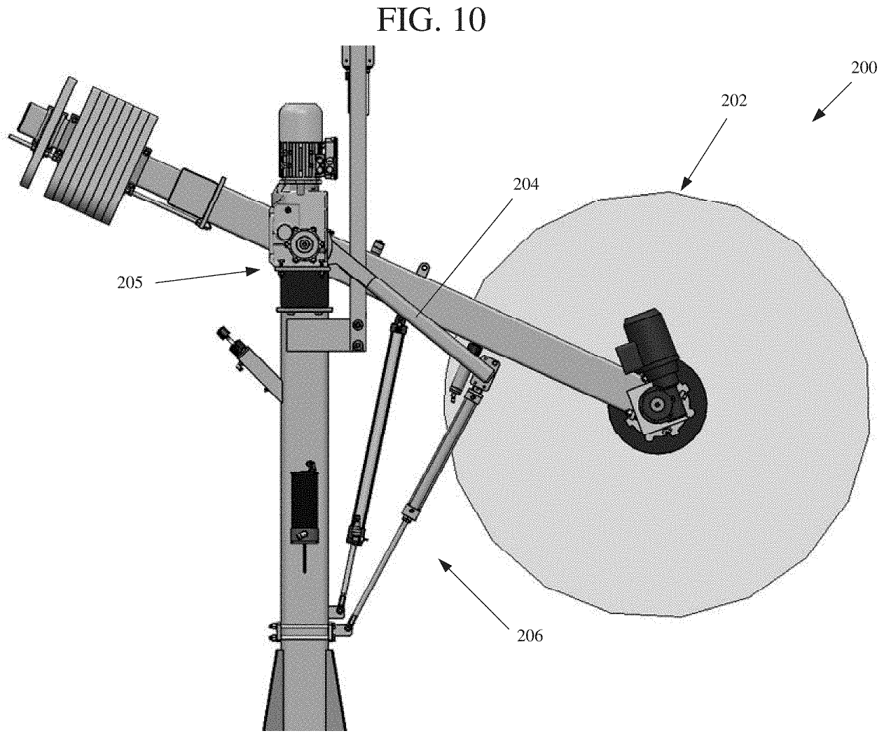

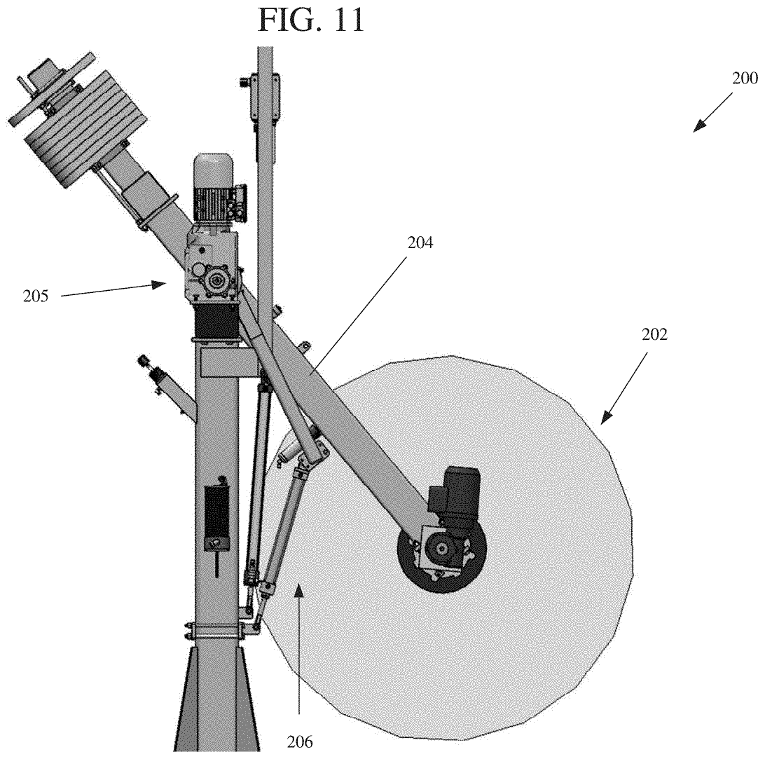

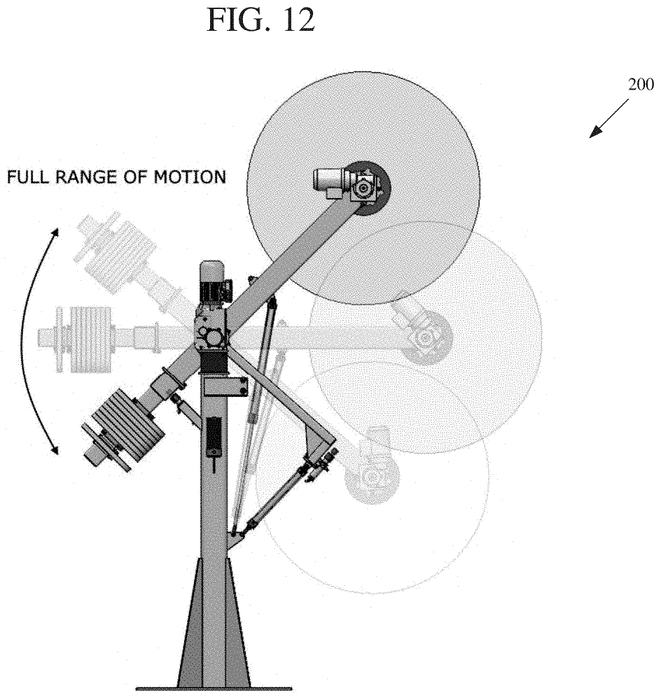

In various embodiments, the washing equipment 114 of the car wash system 110 can include an adjustable top washer 200, as shown in FIGS. 2-12. The top washer 200 can be adjustable between various heights or positions based on the size, height, speed, and/or type of vehicle 112 being washed by the car wash system 110. In one embodiment, the size, height, and/or type of the vehicle 112 can be sensed by a sensor 118a of a scanning arch 118. The top washer 200 can include a rotary brush head 202 that is positioned at the distal end of an arm assembly 204, wherein the arm assembly 204 is configured to move the rotary brush head 202 through a range of positions. The top washer 200 can further include an actuator 205 that is configured to actuate the arm assembly 204 to move the rotary brush head 202 through its range of movement and/or between various positions. The actuator 205 can be communicably coupled to the control system 122 such that the actuator 205 can be controlled thereby. In one embodiment, the control system 122 of the car wash system 110 can sense a height of the vehicle 112 or a portion thereof (e.g., a height of the head of the vehicle 112) and adjust the position of the rotary brush head 202 by controlling the actuator 205 accordingly. In one embodiment, the top washer 200 can further include a counterweight assembly 208 to balance the weight of the rotary brush head 202 and thereby allow for the repositioning thereof.

As noted above, it can be highly beneficial in order to properly position the top washer 200 and/or the rotary brush head 202 thereof properly with respect to the vehicle 112 being washed. As can be seen in FIG. 2, if the center line of the rotary brush head 202 is positioned below the hood of the vehicle 112, then the rotary brush head 202 can become trapped against the hood of the vehicle 112, which can result in damage to the vehicle 112 and/or the top washer 200. Therefore, the control system 122 can be configured to adjust the position or head of the rotary brush head 202 based on the properties of the vehicle 112 being washed. In one embodiment, the control system 122 can be programmed or otherwise configured to receive the height measurement of the vehicle from a sensor (e.g., the sensor arch 118 or a sensor 118a thereof), determine whether a position of the top washer is suitable for the vehicle 112 (e.g., whether a centerline of the rotary brush head 202 is at or below the hood height of the vehicle 112) based on the received height measurement, and control the actuator 205 to cause the top washer 200 to move from the initial or first position to a second position (e.g., a position where the centerline of the rotary brush head 202 is at or above the hood height of the vehicle 112).

In one embodiment, the actuator 205 can include an air cylinder (which can be the second or supplemental air cylinder for the top washer 200). In this embodiment, the control system 122 can be programmed to activate the air cylinder between two sequential vehicles being washed by the car wash system 110 if the second or following vehicle has a higher hood than the first vehicle. Accordingly, in this embodiment, the control system 122 can identify oversized vehicles that require the activation of the cylinder to lift the rotary brush head 202. In another embodiment, the car wash system 110 could be programmed to accept input from a user (e.g., an attendant of the car wash system 110) that allows for the air cylinder to be manually activated. Accordingly, these embodiments allow the top washer 200 to be adjusted between a low vehicle position and a high vehicle position based on the characteristics of the vehicle 112 being washed in order to start washing the vehicle 112 at an appropriate height.

In one embodiment, the actuator 205 can include a gear motor. In this embodiment, the gear motor and the clutch can be configured to position the top washer 200 and/or the rotary brush head 202 at one of several different positions. For example, the scanning arch 118 could measure the exact height of the hood of the vehicle 112 and, accordingly, the control system 122 then the gear motor will position the top washer optimally for the measured vehicle height. Additionally, in this embodiment, the control system 122 could be programmed to measure the torque or amps of the gear motor spinning the top washer 200 and continuously control the positioning of the rotary brush head 202 accordingly. For example, if there is too much penetration of the vehicle 112 by the rotary brush head 202, the motor torque would increase. Accordingly, the control system 122 could detect this increase in motor torque and adjust the position of the rotary brush head 202 (e.g., lift the rotary brush head 202) based on the sensed torque until a target torque is reached or maintained. Correspondingly, if the sensed motor torque is too low, the control system 122 could adjust the position of the rotary brush head 202 (e.g., lower the rotary brush head 202) in order to increase the penetration and torque. This embodiment can be beneficial because by sensing the motor torque, the control system 122 can ensure that the top washer 200 cleans the vehicle 112 with optimal penetration. Accordingly, these embodiments provide more initial positioning accuracy between sequential vehicles being washed by the car wash system 110, but can also assist the car wash system 110 in providing an optimal wash for each individual vehicle.

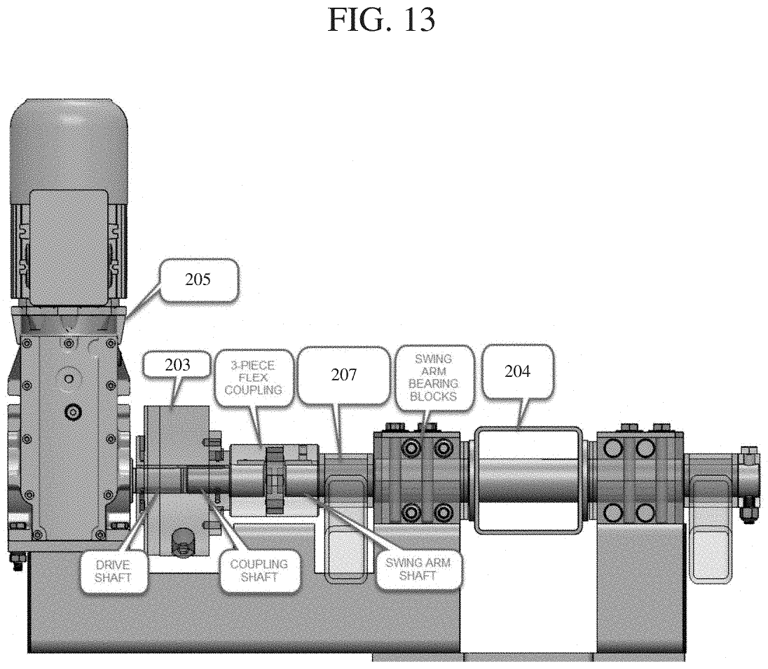

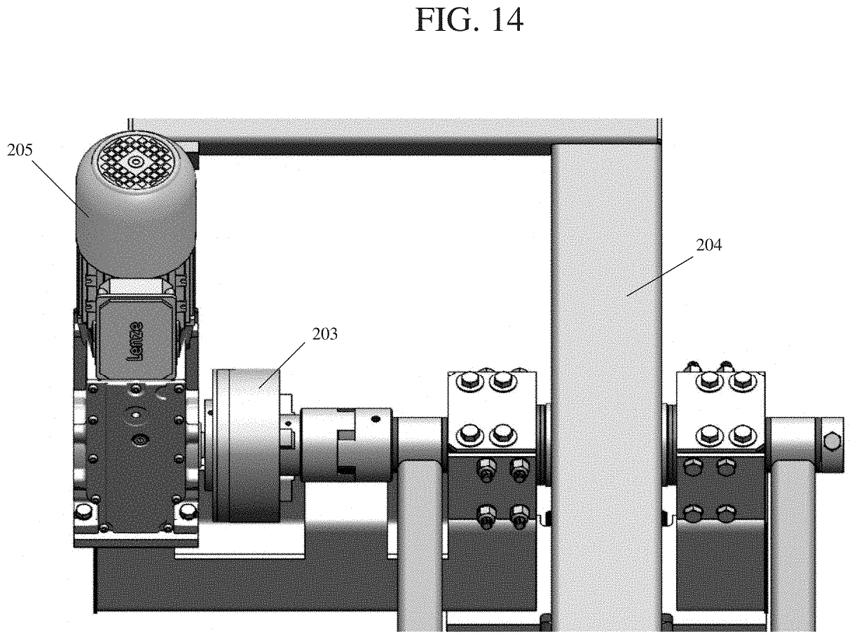

In one embodiment, the actuator 206 (e.g., gear motor) can be coupled to the arm assembly 204 via a breakaway clutch 203, such as is shown in FIGS. 13 and 14. The breakaway clutch 203 can be configured to disconnect the rotary brush head 202 from the actuator 205 (e.g., gear motor) in the event that the vehicle 112 impacts the rotary brush head 202 with at least a threshold amount of force. In the illustrated embodiment, the breakaway clutch 203 is configured to interchangeably couple the drive shaft of the actuator 205 to the swing arm shaft of the arm assembly 204 via a coupling shaft. The top washer 200 can further include various other mechanical components, such as a flex coupling, an adjustable stop arm 207 (which is described in further detail below), and/or bearing locks. Further, when the breakaway clutch 203 disconnects from the rotary brush head 202 from the actuator 205, the amperage or torque of the actuator 205 will drop rapidly, thereby signaling that the breakaway event has occurred. In one embodiment, the control system 122 can take a variety of different actions when a breakaway event occurs, including retracting the top washer 200 (e.g., via the actuator 206), stopping the conveyor 120, and/or sending an alert.

As described above, the height of the vehicle hood can be determined via the scanning arch 118, which in turn allows the control system 122 to position the rotary brush head 202 at the proper or optimal height for the front end of the vehicle 112. This allows for the rotary brush head 202 to be positioned more accurately for the particular vehicle type being washed by the car wash system 110 than conventional systems. Further, once the rotary brush head 202 is on the hood of the vehicle, the torque required to turn the rotary brush head 202 can be used as a target by the control system 122. In particular, if the control system 122 detects too much torque on the actuator 205, the control system 122 can control the top washer 200 to lift the rotary brush head 202 (i.e., reposition the rotary brush head 202 farther from the vehicle 112). Conversely, if the control system 122 detects too little torque on the actuator 205, the control system 122 can control the top washer 200 to drop the rotary brush head 202 (i.e., reposition the rotary brush head 202 closer towards the vehicle 112). Accordingly, the control system 122 can achieve optimal penetration for the rotary brush head 202 with respect to the vehicle 112 by following the targeted torque value. Embodiments where the actuator 105 includes a breakaway clutch 203 can be beneficial because it allows for the height of the rotary brush head 202 to be set to the exact vehicle height, which in turn allows for the top washer 200 to clean the vehicle 112 with exact accuracy for the particular vehicle profile and/or contours. In conventional car wash systems, there is no ability to position the top washer 200 based on the height of the vehicle 112, which can cause the top washer 200 to become trapped against the vehicle 112. Further, conventional car wash systems also lack a sensor to sense or determine the height of the hood of the vehicle 112. Because conventional car wash systems cannot reposition the top washer 200 or sense the particular hood height of the vehicle 112, they tend to be overly conservative in the positioning of the top washer 200 because any deviation in the positioning of the rotary brush head 202 from the exact intended position and/or any deviation in the sensed vehicle height from the actual vehicle height could cause the rotary brush head 202 to be improperly positioned with respect to the vehicle 112, which in turn could cause the rotary brush head 202 to become trapped against the vehicle. Therefore, conventional car wash systems could generally favor being conservative in the positioning of the rotary brush head 202 of the top washer 200 in order to avoid significant system faults (e.g., the rotary brush head 202 becoming trapped against a vehicle or contacting the vehicle 112 or the stops 210 with too much force) caused by sensing and/or positioning deviations. While being conservative in the positioning of the rotary brush head 202 can address these issues, it also results in an overall poorer wash for the vehicle 112. However, the embodiments where the top washer 200 includes a breakaway clutch 203 can be especially beneficial because it mitigates the impact of the rotary brush head 202 not being positioned at the precise correct height, which in turn makes it more desirable to attempt to position the rotary brush head 202 at the exact location that is appropriate for the given vehicle type being washed. Namely, if the rotary brush head 202 happens to not be positioned at the exact proper height for the vehicle 112, then the breakaway clutch 203 will be engaged and the rotary brush head 202 will be disengaged from the actuator 205, which in turn prevents any damage to the actuator 205 or other components of the top washer 200.

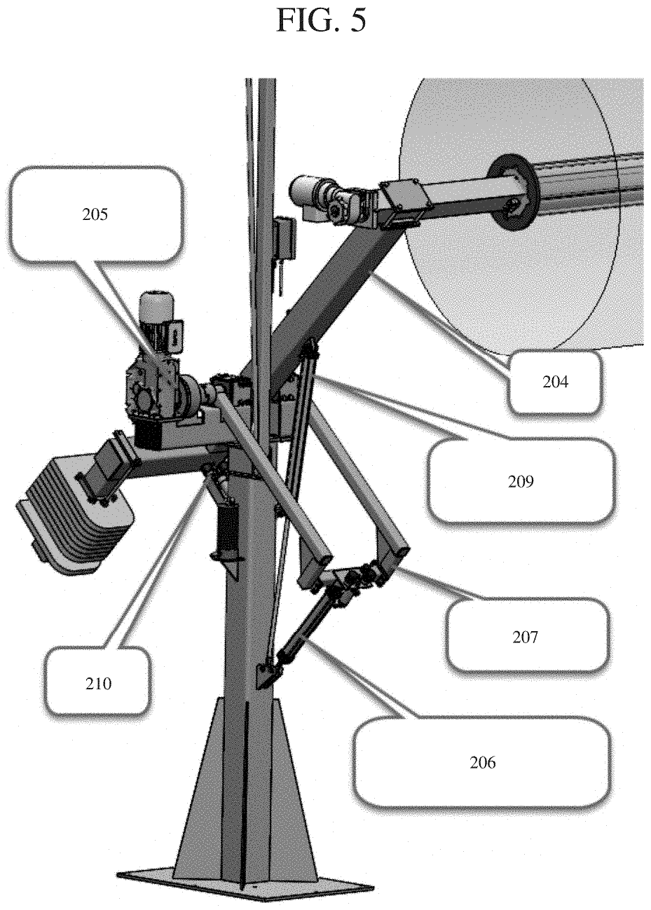

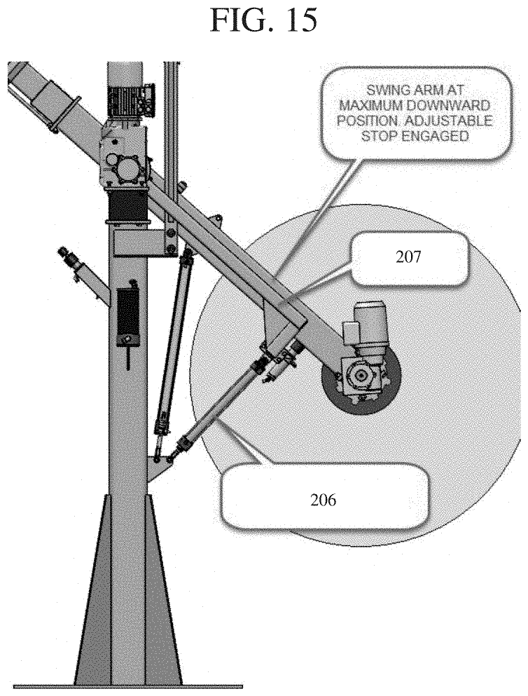

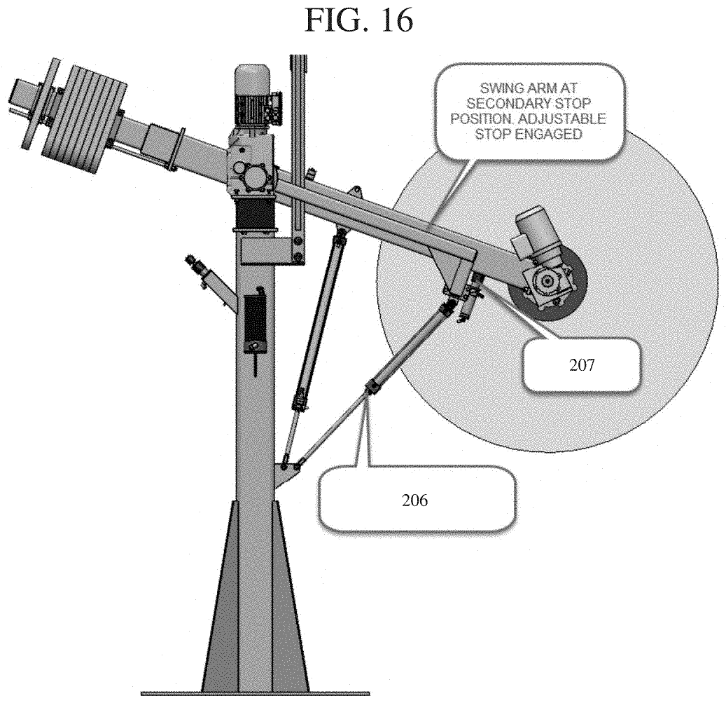

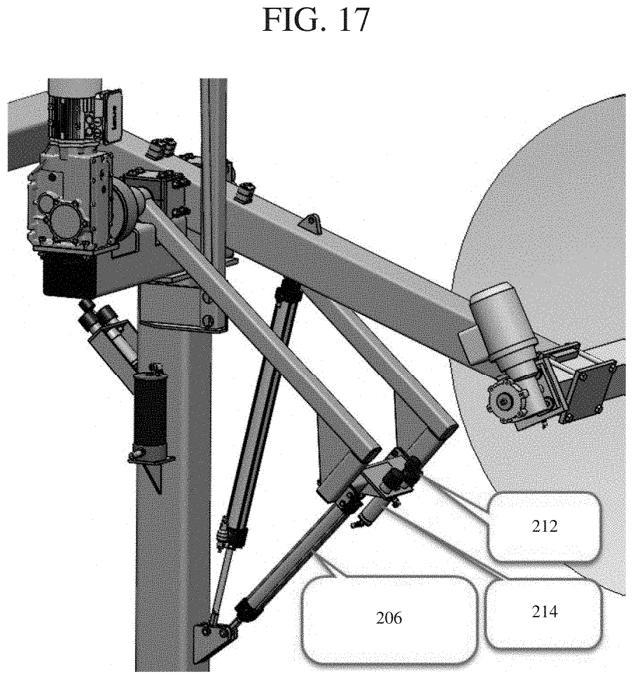

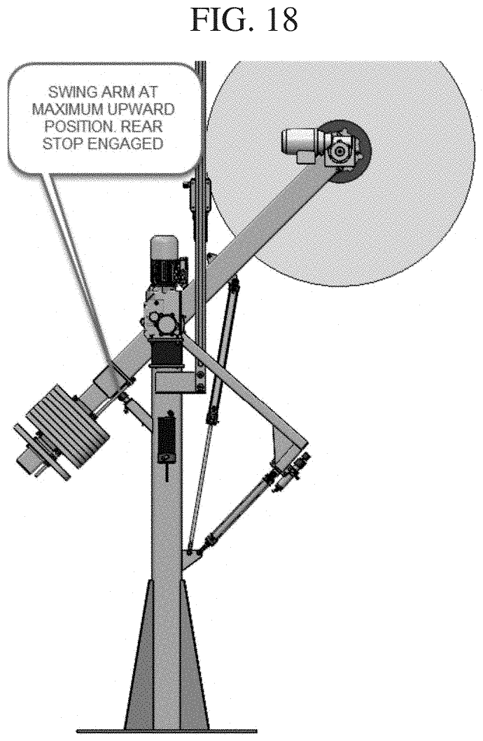

In one embodiment, the top washer 200 can include a first stop (sometimes referred to as the “downward stop assembly”) configured to set the bottom stop position for the top washer 200, i.e., the position below which the rotary brush head 202 will not drop, as shown in FIGS. 15 and 16. The first stop can include an adjustable stop arm 207 and an actuator 206 coupled thereto that is controlled to control the positioning of the adjustable stop arm 207. The actuator 206 can include a pneumatic actuator, for example. In one embodiment, the actuator 206 can be communicably coupled to the control system 122 such that the actuator 206 can be controlled thereby. In another embodiment, the actuator 206 can be manually controllable by a user (e.g., the car wash attendants). Further, the first or downward stop position can be adjustable. For example, FIG. 15 shows the top washer 200 at its maximum downward stop position, wherein the actuator 206 is in a collapsed position. As another example, FIG. 16 shows the top washer 200 at a secondary downward stop position, wherein the actuator 206 is in an extended position, which in turn raises the downward stop position relative to the maximum downward stop position shown in FIG. 15. The first stop assembly can further include one or more bumpers 212 (e.g., rubber bumpers) and/or cushions 214 (e.g., pneumatic actuator cushions), as shown in FIG. 17, for example. In one embodiment, the top washer 200 can further include a second stop 210 (FIG. 5; sometimes referred to as the “rear stop” or “upward stop assembly”) configured to set the top stop position for the top washer 200, i.e., the position above which the rotary brush head 202 will not lift, as shown in FIG. 18. It should be noted that in alternative embodiments, the second stop 210 can include an adjustable stop assembly, similarly as with the embodiments of the first stop illustrated in FIGS. 16 and 17.

In sum, described herein are embodiments of an adjustable top washer assembly and a car wash system incorporating such a top washer assembly. The embodiments described herein prevent the top washer from being trapped between vehicles. The embodiments described herein significantly improve the performance of top washers for car wash systems, while reducing equipment and vehicle damage by eliminating drastic movement of the top washer between vehicles being washed by the car wash system.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A car wash system for washing a vehicle, the car wash system comprising:
a sensor configured to determine a height measurement of the vehicle;
a top washer assembly configured to wash a top of the vehicle, the top washer assembly comprising:
a rotary brush configured to move between a first position and a second position; and
an actuator coupled to the rotary brush, the actuator configured to move the rotary brush between the first position and the second position; and
a control system coupled to the actuator and the sensor, the control system configured to:
receive the height measurement of the vehicle from the sensor; and
control the actuator to cause the top washer to be positioned at the first position or the second position based on the received height measurement.

2. The car wash system of claim 1, wherein the first position corresponds to where a centerline of the rotary brush is below a hood of the vehicle and the second position corresponds to where the centerline is above the hood of the vehicle.

3. The car wash system of claim 1, wherein the top washer assembly further comprises:
a breakaway clutch coupled to the actuator and the rotary brush, the breakaway clutch configured to disconnect the rotary brush from the actuator in response to the vehicle contacting the rotary brush with at least a threshold amount of force.

4. The car wash system of claim 1, wherein the actuator comprises a gear motor.

5. The car wash system of claim 1, further comprising:
a conveyor belt configured to move the vehicle through the car wash system.

6. A car wash system for washing a vehicle, the car wash system comprising:
a sensor configured to determine a height measurement of the vehicle;
a top washer assembly configured to wash a top of the vehicle, the top washer assembly comprising:
a rotary brush; and
an actuator coupled to the rotary brush, the actuator configured to move the rotary brush between a first position and a second position; and
a control system coupled to the actuator and the sensor, the control system configured to:
receive the height measurement of the vehicle from the sensor; and
control the actuator to adjust the position of the top washer based on the received height measurement.

7. The car wash system of claim 6, wherein the first position corresponds to where a centerline of the rotary brush is below a hood of the vehicle and the second position corresponds to where the centerline is above the hood of the vehicle.

8. The car wash system of claim 6, wherein the top washer assembly further comprises:
a breakaway clutch coupled to the actuator and the rotary brush, the breakaway clutch configured to disconnect the rotary brush from the actuator in response to the vehicle contacting the rotary brush with at least a threshold amount of force.

9. The car wash system of claim 6, wherein the actuator comprises a gear motor.

10. The car wash system of claim 6, further comprising:
a conveyor belt configured to move the vehicle through the car wash system.

11. A car wash system for washing a vehicle, the car wash system comprising:
a sensor configured to determine a height measurement of the vehicle;
a top washer assembly configured to wash a top of the vehicle, the top washer assembly comprising:
a rotary brush configured to move between a plurality of positions; and
an actuator coupled to the rotary brush, the actuator configured to move the rotary brush between the plurality of positions; and
a control system coupled to the actuator and the sensor, the control system configured to:
receive the height measurement of the vehicle from the sensor; and
control the actuator to cause the top washer to be positioned at a position that corresponds to the height measurement of the vehicle.

12. The car wash system of claim 1, the sensor being one of a plurality of sensors disposed on a sensor arch.

13. The car wash system of claim 3, wherein in response to the disconnection of the rotary brush from the actuator, the control system is configured to:
sense a reduction in one or more of amperage or torque in the breakaway clutch;
perform an action selected from a group of actions, the group of actions comprising: raising the rotary brush, stopping a conveyor belt, and sending an alert.

14. The car wash system of claim 1, wherein the control system is configured to:
detect a torque of the rotary brush; and
adjust the position of the rotary brush in response to the torque.

15. The car wash system of claim 1, wherein the actuator comprises an air cylinder.

16. The car wash system of claim 1, wherein the sensor is further configured to determine a height of a subsequent vehicle, and
wherein the control system is further configured to activate the actuator in response to the sensor determining that the height of the subsequent vehicle is greater than the height of the vehicle.

17. The car wash system of claim 6, the sensor being one of a plurality of sensors disposed on a sensor arch.

18. The car wash system of claim 8, wherein in response to the disconnection of the rotary brush from the actuator, the control system is configured to:
sense a reduction in one or more of amperage or torque in the breakaway clutch;
perform an action selected from a group of actions, the group of actions comprising: raise the rotary brush, stopping a conveyor belt, and sending an alert.

19. The car wash system of claim 6, wherein the control system is configured to:
detect a torque of the rotary brush; and
adjust the position of the rotary brush in response to the torque.

20. The car wash system of claim 6, wherein the actuator comprises an air cylinder,
wherein the sensor is further configured to determine a height of a second vehicle, and
wherein the control system is further configured to activate the air cylinder in response to the sensor determining that the height of the second vehicle is greater than the height of the first vehicle.
